(19) United States
(12) Patent Application Publication
(10) Pub. No.: US 2026/0264521 A1
(43) Pub. Date: Sep. 10, 2026

(54) VEHICULAR DISPLAY DEVICE

(71) Applicant: TOYOTA JIDOSHA KABUSHIKI KAISHA, Toyota-shi (JP)

(72) Inventor: Kohji SONOHARA, Nagoya-shi (JP)

(73) Assignee: TOYOTA JIDOSHA KABUSHIKI KAISHA, Toyota-shi (JP)

(21) Appl. No.: 19/529,398

(22) Filed: Feb. 4, 2026

(30) Foreign Application Priority Data
Feb. 20, 2025 (JP) 2025-025562

(51) Int. Cl. B60K 35/28; B60K 35/22; B60K 35/81

(52) U.S. Cl. CPC B60K 35/28; B60K 35/22; B60K 35/81; B60K 2360/119; B60K 2360/1868; B60K 2360/21

(57) ABSTRACT

A vehicular display device for displaying a traffic signage icon corresponding to a traffic signage in front of a vehicle recognized by an external camera of the vehicle on a display in an external camera, wherein when the traffic signage icon is displayed on a display in a vehicle cabin, a driving handling method associated with the traffic signage in advance is displayed on the display.

### CROSS-REFERENCE TO RELATED APPLICATION

This application claims priority to Japanese Patent Application No. 2025-025562 filed on Feb. 20, 2025. The disclosure of the above-identified application, including the specification, drawings, and claims, is incorporated by reference herein in its entirety.

### BACKGROUND

### 1. Technical Field

The present disclosure relates to a vehicular display device.

### 2. Description of Related Art

Conventionally, Japanese Unexamined Patent Application Publication No. 2014-120113 (JP 2014-120113 A) is known as a technical document related to a vehicular display device. This publication discloses technology for displaying a road sign recognized by a camera of a vehicle on a display in a vehicle cabin.

### SUMMARY

However, there is a problem that it is not easy for an inexperienced driver to associate an appropriate driving action with a road sign simply displayed on the display in the vehicle cabin.

One aspect of the present disclosure is a vehicular display device of a vehicle, for displaying a traffic signage icon corresponding to a traffic signage ahead of the vehicle that is recognized by an external camera of the vehicle, on a display in a vehicle cabin, in which,

when the traffic signage icon is displayed on the display, a driving handling method that is associated with the traffic signage in advance is displayed on the display.

In the vehicular display device according to an aspect of the present disclosure,

when the external camera of the vehicle recognizes an application-conditional traffic signage, determination may be made regarding whether a state of the vehicle satisfies an applicable condition of the application-conditional traffic signage, and

when determination is made that the state of the vehicle satisfies the applicable condition, the traffic signage icon corresponding to the application-conditional traffic signage, and the driving handling method associated with the traffic signage in advance, may be displayed on the display, and when determination is made that the state of the vehicle does not satisfy the applicable condition, the traffic signage icon and the driving handling method do not have to be displayed on the display.

In the vehicular display device according to an aspect of the present disclosure,

when the external camera of the vehicle recognizes a time-conditional traffic signage, determination may be made regarding whether a current time satisfies a time condition of the time-conditional traffic signage, and

when determination is made that the current time satisfies the time condition, the traffic signage icon corresponding to the traffic signage, and a driving handling method for when satisfying the time condition associated with the traffic signage icon in advance, may be displayed on the display, and when determination is made that the current time does not satisfy the time condition, the traffic signage icon, and a driving handling method for when not satisfying the time condition associated with the traffic signage icon in advance, may be displayed on the display.

In the vehicular display device according to an aspect of the present disclosure,

the display includes a first display, and a second display of which a screen display is larger than that of the first display, and

when the traffic signage icon is displayed on the first display or the second display, the driving handling method associated with the traffic signage icon in advance is displayed on the first display, and also a detailed description of the traffic signage icon is displayed on the second display.

According to each of the aspects of the present disclosure, a traffic signage icon corresponding to a traffic signage recognized by an external camera, and a driving handling method that is associated with the traffic signage in advance, are displayed on a display in a vehicle cabin. At this time, the driver can easily comprehend the traffic signage and the driving handling method. Accordingly, the present disclosure has an effect of reducing a recognition load of the driver.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a vehicular display device according to an embodiment;

FIG. 2A is a diagram illustrating an example of a time-conditional roadway sign;

FIG. 2B is a diagram illustrating an exemplary of a driving handling method in a MID;

FIG. 2C is a diagram showing an exemplary indication of a traffic sign icon and a detailed explanation in a center display;

FIG. 3A is a diagram illustrating an example of a vehicle type conditional road sign;

FIG. 3B is a diagram illustrating an exemplary of a driving handling method in a MID;

FIG. 4A is a diagram illustrating an example of a vehicle-stopping road sign and a driving handling method;

FIG. 4B is a diagram illustrating an example of a road sign for stopping passage and a driving handling method;

FIG. 4C is a diagram illustrating an example of an approach no entry road sign and a driving handling method;

FIG. 5 is a diagram illustrating an example of a road sign icon for stopping vehicle traffic in a center display and a display of a detailed description;

FIG. 6 is a flowchart illustrating an exemplary display process of a traffic signage icon and a driving handling method in the vehicular display device; and

FIG. 7 is a flowchart illustrating an example of a display process in the case of the traffic signage with application conditions in the vehicular display device.

### DETAILED DESCRIPTION OF EMBODIMENTS

Hereinafter, an embodiment of the disclosure will be described with reference to the drawings.

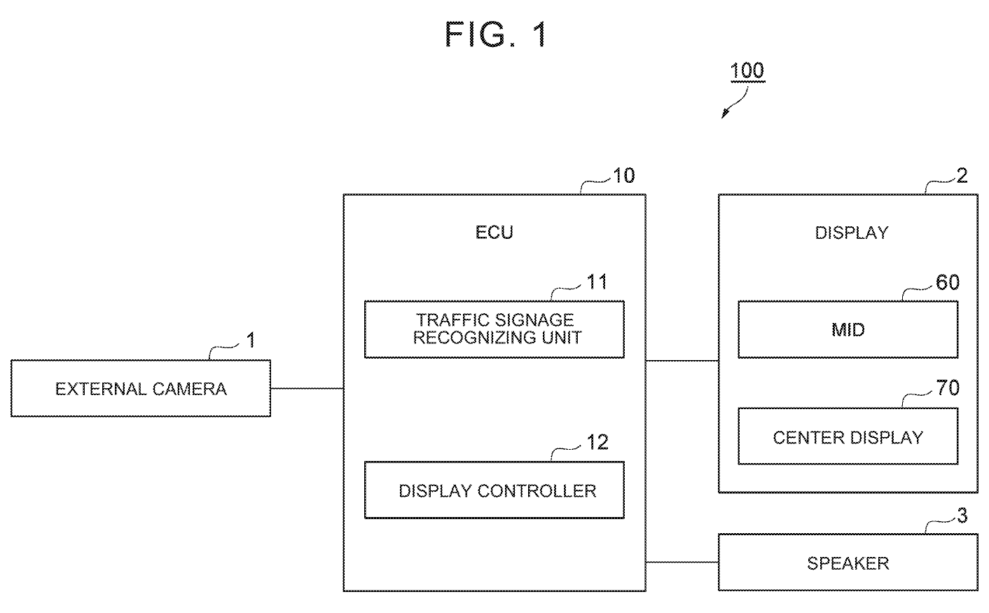

FIG. 1 is a block diagram illustrating a vehicular display device 100 according to an embodiment. The vehicular display device 100 illustrated in FIG. 1 is mounted on a vehicle (hereinafter referred to as a vehicle) such as a passenger car or a freight car, and is a device that displays information on a traffic signage recognized by an external camera mounted on the vehicle on a display in a vehicle cabin. The traffic signage is, for example, a sign indicating information related to traffic. Specifically, the traffic signage includes at least one of a road sign, a road surface sign, a traffic guide board, and the like.

The vehicular display device 100 includes an ECU (Electronic Control Unit 10. ECU 10 is an electronic control unit having a CPU (Central Processing Unit) and a storage. The storage unit includes, for example, ROM (Read Only Memory), RAM (Random Access Memory), EEPROM (Electrically Erasable Programmable Read-Only Memory), and the like. In ECU 10, for example, various functions are realized by executing a program stored in a storage unit by a CPU. ECU 10 may be composed of a plurality of electronic units.

ECU 10 is connected to the external camera 1, the display 2, and the speaker 3. The external camera 1 is an imaging device that captures an image of an external state of the vehicle. The external camera 1 is provided, for example, on the rear side of the windshield of the vehicle and includes a front camera that captures an image of the front of the vehicle. The external camera 1 may include a rear camera that captures an image of the rear of the vehicle and a side camera that captures images of the left and right sides of the vehicle. The external camera 1 transmits captured images related to the external conditions of the vehicles to ECU 10.

The display 2 is a device that is provided in the vehicle cabin and displays various kinds of information on a driver of the vehicle. The display 2 includes a MID 60 (multi-information display) serving as a first display and a center display 70 serving as a second display.

A MID 60 is a display that forms part of an instrument panel within the field of view of a driver and is designed to quickly provide driving related information. In particular, MID 60 is integrated into the meter panel of the vehicle and is displayed with other operating data, such as a speedometer or fuel-gauge. Thus, the driver can immediately confirm the necessary information without moving the line of sight greatly.

The center display 70 is a second display disposed in a central portion of the vehicle, and is used to provide detailed information and explanation. The center display 70 is located in a position that is easily visible to the driver and the passenger, and has a large display area for displaying more information than MID 60.

The speaker 3 is a device for outputting voice guidance and a warning sound to the driver. As an example, the speaker 3 is provided inside the door of the vehicle or on the back side of the meter panel.

Next, the functional configuration of ECU 10 will be described. As illustrated in FIG. 1, ECU 10 includes a traffic signage recognizing unit 11 and a display control unit 12.

The traffic signage recognizing unit 11 analyzes an image acquired from the external camera 1 and recognizes a traffic signage including a road sign. The traffic signage recognizing unit 11 executes various algorithms for recognizing the traffic signage with high accuracy, for example. Specifically, the traffic signage recognizing unit 11 extracts a feature amount from an image by using an image processing technique, and identifies the type and the content of the traffic signage by collating the feature amount with a pre-registered sign database. For example, a stop sign, a speed limit sign, a no entry sign, and the like are recognized on the basis of characteristics such as shape, color, and character information.

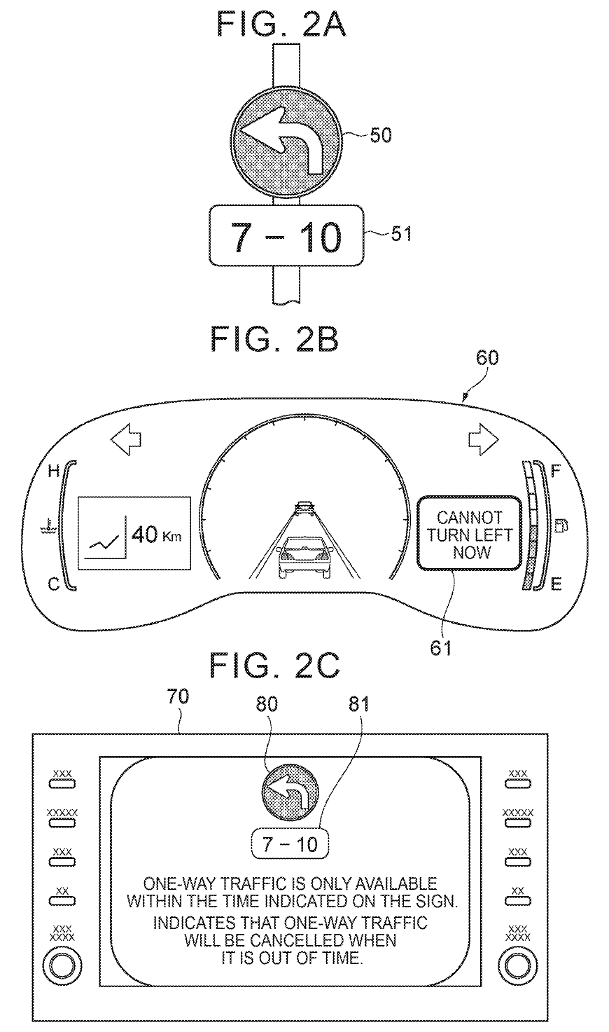

Here, FIG. 2A is a diagram illustrating an exemplary time-conditional roadway sign. The time conditional road sign is a road sign in which the application contents of the rules and the like indicated on the road sign are changed according to the time zone.

The traffic signage recognizing unit 11 recognizes the time-conditional road sign 50 shown in FIG. 2A based on the images captured by the external cameras 1. The time conditional road sign 50 is provided with a time conditional display 51 in which a time condition of "7-10" is described. The time conditional road sign 50 shown in FIG. 2A indicates that a left turn is not allowed in a particular time period (from 7 o'clock to 10 o'clock).

The traffic signage recognizing unit 11 may use a machine learning algorithm in order to improve recognition accuracy. For example, an image recognition model using deep learning is trained to improve the accuracy of sign recognition under various environments. In addition, the traffic signage recognizing unit 11 may cooperate with GPS data and the map information to complement the position information of the traffic signage and further improve the recognition accuracy.

The display control unit 12 displays various kinds of information corresponding to the traffic signage recognized by the traffic signage recognizing unit 11 on the display 2. The display control unit 12 receives the recognition result sent from the traffic signage recognizing unit 11, and generates display contents based on the recognition result.

The display control unit 12 displays, for example, a traffic signage icon and a driving handling method associated with the traffic signage in advance on the display 2. The traffic signage icon is an icon corresponding to a traffic signage such as a road sign. driving handling methods are measures to be taken by driving a driver in order to comply with the regulations and the like indicated in the traffic signage. The traffic signage icon and the driving handling method are stored in the storage unit of the vehicle in association with the traffic signage in advance. The traffic signage icon may be created by clipping the traffic signage from the actual captured image.

Further, the display control unit 12 may display a detailed description corresponding to the traffic signage on the display 2. The detailed description corresponding to the traffic signage may be stored in association with the traffic signage or may be generated by a machine learning model. The detailed description is an explanatory text having a larger number of characters than the driving handling method.

Here, FIG. 2B is a diagram illustrating an exemplary indication of a driving handling method in MID 60. When the time conditional road sign 50 and the time conditional display 51 shown in FIG. 2A are recognized by the traffic signage recognizing unit 11, the display control unit 12 determines whether or not the present time satisfies the time condition. When it is determined that the present time satisfies the time condition, the display control unit 12 displays, in the text window 61 of MID 60, the driving handling method when the time condition is satisfied among the driving handling methods stored in association with the time conditional road sign 50. The display control unit 12 displays, for example, a driving handling method "cannot turn left at present" on MID 60.

On the other hand, when it is determined that the current time does not satisfy the time condition, the display control unit 12 displays the driving handling method when the time condition is not satisfied among the driving handling methods stored in association with the time conditional road sign 50. This driving handling method is displayed in the text window 61 of MID 60. The display control unit 12 displays, for example, a driving handling method called "Currently, can turn left" on MID 60.

FIG. 2C is a diagram illustrating an example of a road sign icon and a detailed explanation display on a center display 70. The display control unit 12 displays the road sign icon 80 stored in association with the time conditional road sign 50 recognized by the traffic signage recognizing unit 11 and the time conditional display icon 81 stored in association with the time conditional display 51 on the center display 70. Note that the display control unit 12 may display the road sign icon 80 on MID 60, or may display the road sign icon 80 on both MID 60 and the center display 70.

Further, the display control unit 12 acquires a detailed description of the time-conditional road sign 50 from the storage unit or generates a detailed description of the time-conditional road sign by using a machine learning model. For example, as shown in FIG. 2C, the display control unit 12 makes one-way traffic only within the period indicated by the indicator. Indicates that one-way traffic will be cancelled when it is out of time. " A detailed description of this is displayed on the center display 70. The display control unit 12 may change the details of the detailed description depending on whether or not the current time satisfies the time condition.

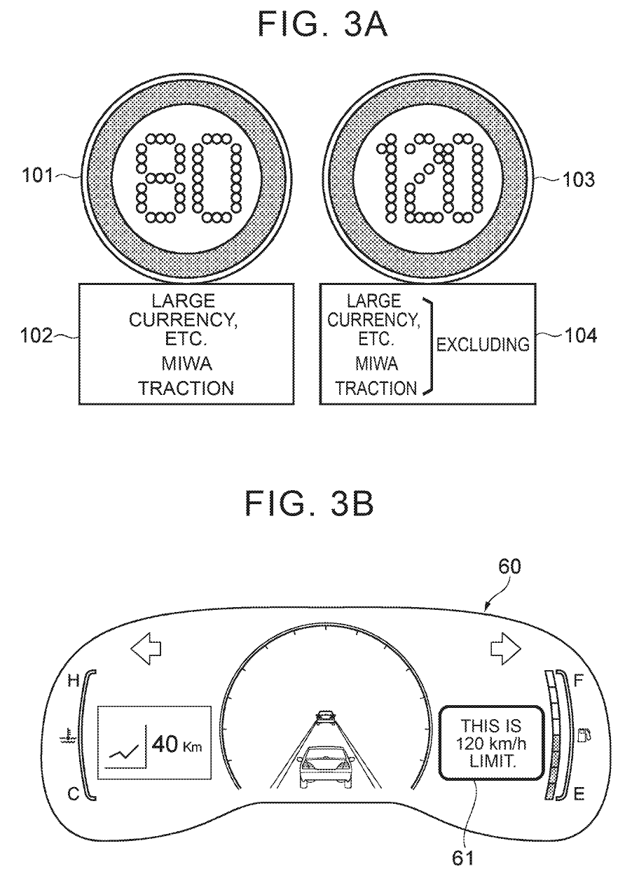

Next, a case of a vehicle type conditional road sign will be described. The vehicle type conditional road sign is a road sign in which the application contents of the rules and the like indicated on the road sign are changed depending on the vehicle type. FIG. 3A is a diagram illustrating an example of a vehicle type conditional road sign. In FIG. 3A, the first vehicle type conditional road sign 101 and the first vehicle type conditional display 102, and the second vehicle type conditional road sign 103 and the second vehicle type conditional display 104 are illustrated.

The first vehicle-type conditional road sign 101 indicates a speed limit of "80", and the first vehicle-type condition display 102 under the speed limit indicates a vehicle-type condition of "large-freight, etc. three-wheel traction". This indicates that 80 km/h speed-limiting is applied to large freight vehicles, tricycles, and tractors. Similarly, the second vehicle type conditional road sign 103 indicates a speed limit of "120", and the second vehicle type condition display 104 below the speed limit indicates a vehicle type condition of "excluding the big freight and other tricycle traction". This indicates that 120 km/h speed-limiting is applied to other vehicles except large freight vehicles, tricycles, and tractors.

The traffic signage recognizing unit 11 recognizes the first vehicle type conditional road sign 101 and the first vehicle type conditional display 102 shown in FIG. 3A on the basis of images captured by the external camera 1. Further, the second vehicle type conditional road sign 103 and the second vehicle type conditional display 104 are also recognized.

Based on the recognition result of the traffic signage recognizing unit 11, the display control unit 12 determines that the vehicle type (for example, a passenger car) stored in advance corresponds to "excluding the big freight and other three-wheel traction" in the second vehicle type conditional display 104. Further, the display control unit 12 determines that the speed-limiting 120 km/h of the second vehicle-type conditional road sign 103 is applied.

Based on the determination, the display control unit 12 displays the driving handling method corresponding to the second vehicle type conditional road sign 103 on MID 60. FIG. 3B is a diagram illustrating an exemplary of a driving handling method in a MID 60. For example, as shown in FIG. 3B, the display control unit 12 displays a message "from here, 120 km/h limit is set" on MID 60. The display control unit 12 may display the road sign icon and the detailed description corresponding to the second vehicle type conditional road sign 103 on the center display 70.

On the other hand, the display control unit 12 does not display the first vehicle type conditional road sign 101 that does not satisfy the vehicle type condition. The display control unit 12 may display the road sign icon and the detailed description of the first vehicle type conditional road sign 101 by an operation of the driver on the center display 70 indicating the road sign icon and the detailed description of the second vehicle type conditional road sign 103. In this case, the display control unit 12 displays the information of the first vehicle type conditional road sign 101 in accordance with the operation of the driver.

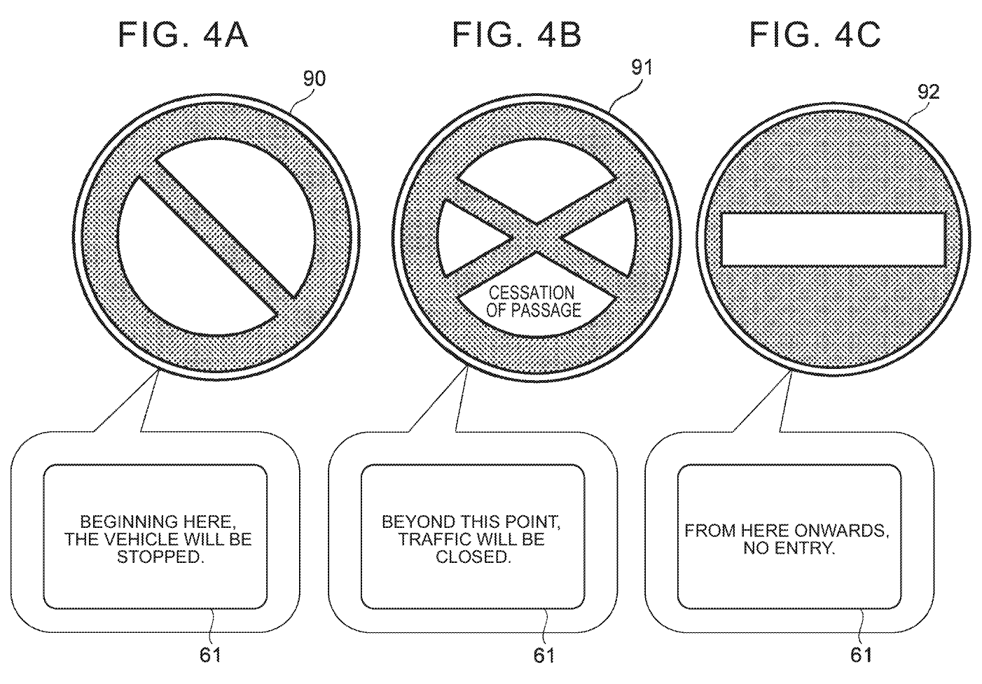

Next, a case of a road sign that is easy to misunderstand will be described. FIG. 4A is a diagram illustrating an example of a vehicle-stopping road sign and a driving handling method. FIG. 4B is a diagram illustrating an example of a road sign for stopping passage and a driving handling method. FIG. 4C is a diagram illustrating an example of a no entry road sign and a driving handling method.

The road sign 90 for stopping the passage of vehicles shown in FIG. 4A is a road sign that bans the passage of all vehicles except the pedestrian. It is installed on a pedestrian road or in a place where the passage of a vehicle is dangerous due to construction work. The road sign 91 shown in FIG. 4B is a road sign that bans the passage of persons or vehicles. It is installed in places where it cannot be physically passed. The road sign 92 of the no entry shown in FIG. 4C is a road sign that bans vehicles from entering the location. It is installed at an exit of one-way traffic or at an intersection with a large traffic volume.

When the traffic signage recognizing unit 11 recognizes the road sign 90 for stopping vehicle traffic, the display control unit 12 displays the driving handling method corresponding to the road sign 90 for stopping vehicle traffic on MID 60. For example, as shown in FIG. 4A, the display control unit 12 displays a message "the vehicle is stopped from here" in the text window 61 of MID 60.

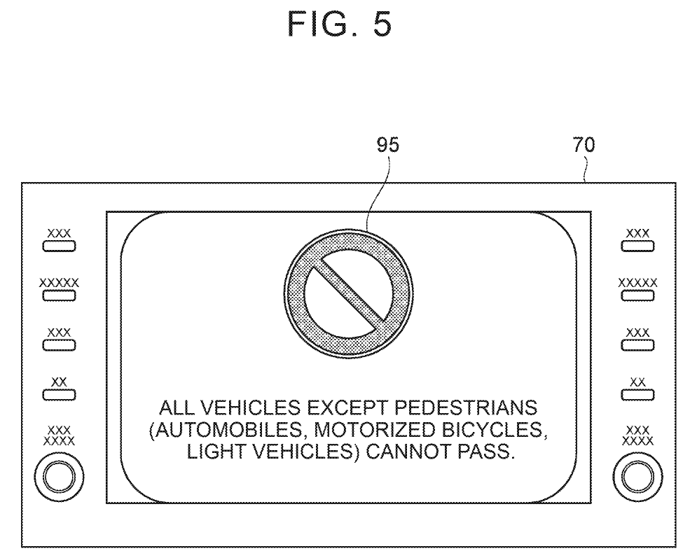

Further, the display control unit 12 displays a road sign icon corresponding to the road sign 90 for stopping vehicle traffic and a detailed description on the center display 70. FIG. 5 is a diagram illustrating an example of a road sign icon 95 for stopping vehicle traffic and a display of a detailed description in the center display 70. As illustrated in FIG. 5, the display control unit 12 displays a road sign icon 95 for stopping vehicle passage and a detailed description on the center display 70. For example, "All vehicles except pedestrians (automobiles, motorized bicycles, and light vehicles) cannot pass through." Content is displayed.

When the traffic signage recognizing unit 11 recognizes the road sign 91, the display control unit 12 displays the driving handling method corresponding to the road sign 91 on MID 60. For example, as shown in FIG. 4B, the display control unit 12 displays a message indicating that the traffic is stopped from here on the text window 61 of MID 60. The display control unit 12 may display a road sign icon and a detailed description on the center display 70.

Similarly, when the traffic signage recognizing unit 11 recognizes the road sign 92 that is no entry, the display control unit 12 displays the driving handling method corresponding to the road sign 92 that is no entry on MID 60. For example, as shown in FIG. 4C of the drawing, the display control unit 12 displays a message "no entry from here" in the text window 61 of MID 60. The display control unit 12 may display a road sign icon and a detailed description on the center display 70.

As described above, in the vehicular display device 100, it is possible to display the driving handling method and the like on the display 2 with respect to the road signs 90 to 92 that are easy to misunderstand. Therefore, it is possible to reduce confusion or anxiety of the driver by looking at the road signs 90 to 92 which are easily misrecognized.

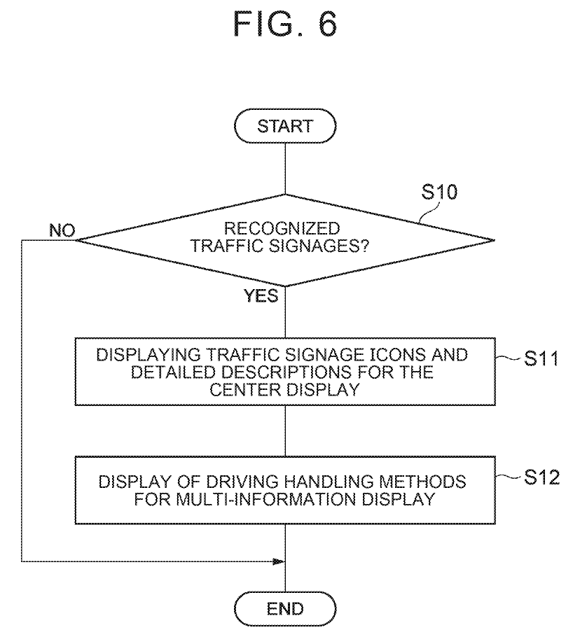

Next, the processing of the vehicular display device 100 according to the present embodiment will be described with reference to the drawings. FIG. 6 is a flowchart illustrating an example of a display process of a traffic signage icon and a driving handling method in the vehicular display device 100. This flowchart illustrates a series of processes for recognizing a traffic signage and displaying appropriate information on the display 2 based thereon.

As illustrated in FIG. 6, ECU 10 of the vehicular display device 100 recognizes, as an S10, a traffic signage in front of the vehicle by the traffic signage recognizing unit 11. When the traffic signage is not recognized (S10: NO), ECU 10 ends the present process. ECU 10 proceeds to S11 when the traffic signage is recognized (S10: YES).

In S11, ECU 10 causes the display control unit 12 to display the traffic signage and the detailed explanation on the center display 70. Specifically, the display control unit 12 acquires the traffic signage icon and the detailed information associated with the traffic signage icon from the storage unit based on the recognition result of the traffic signage recognizing unit 11, and displays the acquired detailed information on the center display 70. The detailed information may be generated by the machine learning model based on the image of the traffic signage.

Next, in S12, ECU 10 causes the display control unit 12 to display the driving handling method for MID 60. Specifically, the display control unit 12 acquires, from the storage unit, a driving handling method corresponding to the traffic signage recognized by the traffic signage recognizing unit 11, and displays the driving handling method on MID 60. the driving handling method may be generated by a machine learning model from an image of the traffic signage and a traveling environment (a traveling lane, a vehicle speed, and the like) of the vehicle. Thereafter, ECU 10 ends the current process.

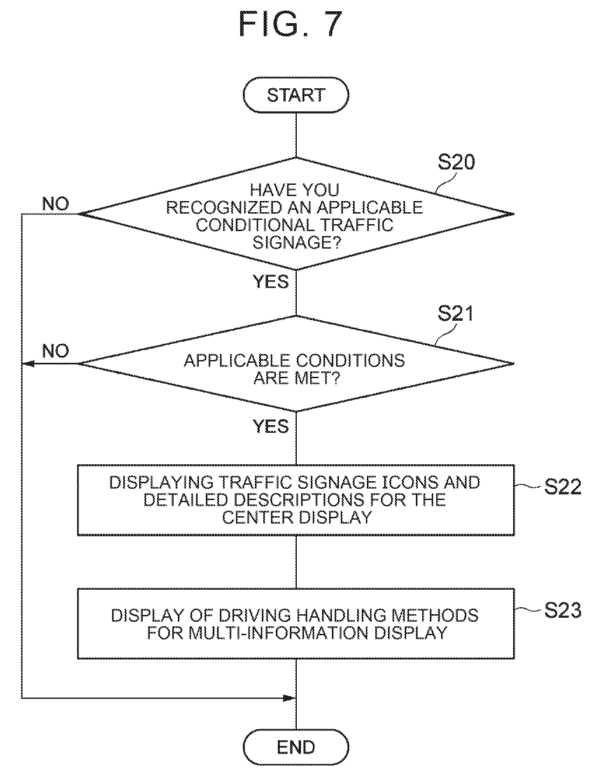

FIG. 7 is a flowchart illustrating an example of display processing in the case of the traffic signage with application conditions in the vehicular display device 100. This flowchart shows a series of processes for recognizing an applied conditional traffic signage and displaying appropriate information on the display 2 based thereon. The application conditional traffic signage is a concept including the above-described time conditional road sign and vehicle type conditional road sign. Not only road signs but also road markings.

As illustrated in FIG. 7, ECU 10 of the vehicular display device 100 recognizes, as an S20, an application-conditional traffic signage in front of the vehicle by the traffic signage recognizing unit 11. ECU 10 terminates the present process when the applicable conditional traffic signage is not recognized (S20: NO). ECU 10 proceeds to S21 when the applied conditional traffic signage is recognized (S20: YES).

In S21, ECU 10 determines whether the application condition of the traffic signage with the application condition is satisfied by the display control unit 12. Specifically, the current time is checked in the case of the time conditional traffic signage, and the type of the vehicle is checked in the case of the vehicle type conditional traffic signage. When ECU 10 does not satisfy the application criteria (S21: NO), the process ends. ECU 10 proceeds to S22 when the application condition is satisfied (S21: YES).

In S22, ECU 10 causes the display control unit 12 to display a traffic signage icon and a detailed explanation to be applied to the center display 70. Specifically, the display control unit 12 acquires the traffic signage icon to be applied and the detailed information associated with the traffic signage icon from the storage unit, and displays the acquired detailed information on the center display 70. The detailed information may be generated by the machine learning model based on the image of the traffic signage.

Next, in S23, ECU 10 causes the display control unit 12 to display the driving handling method when the condition is satisfied on MID 60. Specifically, the display control unit 12 acquires, from the storage unit, a driving handling method when the condition is satisfied corresponding to the traffic signage with the application condition recognized by the traffic signage recognizing unit 11, and displays the driving handling method on MID 60. the driving handling method may be generated by a machine learning model from an image of the traffic signage and a traveling environment (a traveling lane, a vehicle speed, and the like) of the vehicle. Thereafter, ECU 10 ends the current process.

According to the vehicular display device 100 according to the present embodiment described above, the traffic signage icon corresponding to the traffic signage captured by the external camera 1 and the driving handling method associated with the traffic signage are displayed on the display 2. As a result, the driver can easily grasp the traffic signage ahead of the vehicle and the driving handling method.

When the traffic signage recognized by the external camera 1 of the vehicle is a traffic signage with an application condition, the vehicular display device 100 determines whether or not the situation of the vehicle satisfies the application condition. Then, the vehicular display device 100 may display the traffic signage icon and the driving handling method corresponding to the traffic signage on the display 2 only when it is determined that the application condition is satisfied. Thus, unnecessary information is not displayed to the driver, and the visual burden can be reduced. In addition, since the information is displayed only when the application condition is satisfied, the driver can take an appropriate driving action and can comply with traffic regulations.

The vehicular display device 100 determines whether or not the current time satisfies the time condition when the traffic signage recognized by the external camera 1 of the vehicle is a time-conditioned traffic signage. When the time condition is satisfied, the vehicular display device 100 displays a traffic signage icon corresponding to the traffic signage and a driving handling method when the time condition is satisfied on the display 2. In addition, when the time condition is not satisfied, the vehicular display device 100 may not display the traffic signage icon and the driving handling method when the time condition is not satisfied on the display 2. This allows the driver to easily understand the meaning of the time-conditional traffic signage and to take appropriate driving behavior. In particular, it is easy to flexibly deal with traffic restrictions that vary depending on the time zone with an allowance.

The vehicular display device 100 has a configuration including a MID 60 as the display 2 and a center display 70 having a larger screen display than MID 60. When the traffic signage icon is displayed on MID 60 or the center display 70, a driving handling method associated with the traffic signage in advance is displayed on MID 60, and a detailed explanation of the traffic signage icon is displayed on the center display 70. With this configuration, the driver can quickly grasp the traffic signage icon and the driving handling method, and can confirm the detailed description. Further, by displaying the detailed explanation on the center display 70, it is possible to keep the characters from becoming too small as compared with the case where the detailed explanation is displayed on MID 60.

Although the embodiment of the disclosure has been described above, the disclosure is not limited to the embodiment above. The disclosure can be implemented in various modes including various modifications and improvements based on the knowledge of those skilled in the art, including the embodiment as described above.

For example, the first display is not limited to a MID 60, and the second display is not limited to the center display 70. The first display or the second display may be an additional display provided in the vehicle cabin or may be a head-up display. The display 2 may be composed of one display or three or more displays. When the display 2 is composed of one display, the traffic signage icon, the driving handling method, and the detailed description are displayed on the same display. In this case, the detailed description may not be displayed.

What is claimed is:

1. A vehicular display device of a vehicle, for displaying a traffic signage icon corresponding to a traffic signage ahead of the vehicle that is recognized by an external camera of the vehicle, on a display in a vehicle cabin, wherein,
when the traffic signage icon is displayed on the display, a driving handling method that is associated with the traffic signage in advance is displayed on the display.

2. The vehicular display device according to claim 1, wherein,
when the external camera of the vehicle recognizes an application-conditional traffic signage, determination is made regarding whether a state of the vehicle satisfies an applicable condition of the application-conditional traffic signage, and
when determination is made that the state of the vehicle satisfies the applicable condition, the traffic signage icon corresponding to the application-conditional traffic signage, and the driving handling method associated with the traffic signage in advance, are displayed on the display, and when determination is made that the state of the vehicle does not satisfy the applicable condition, the traffic signage icon and the driving handling method are not displayed on the display.

3. The vehicular display device according to claim 1, wherein,
when the external camera of the vehicle recognizes a time-conditional traffic signage, determination is made regarding whether a current time satisfies a time condition of the time-conditional traffic signage, and
when determination is made that the current time satisfies the time condition, the traffic signage icon corresponding to the traffic signage, and a driving handling method for when satisfying the time condition associated with the traffic signage icon in advance, are displayed on the display, and when determination is made that the current time does not satisfy the time condition, the traffic signage icon, and a driving handling method for when not satisfying the time condition associated with the traffic signage icon in advance, are displayed on the display.

4. The vehicular display device according to claim 1, wherein,
the display includes a first display, and a second display of which a screen display is larger than that of the first display, and
when the traffic signage icon is displayed on the first display or the second display, the driving handling method associated with the traffic signage in advance is displayed on the first display, and also a detailed description of the traffic signage is displayed on the second display.
